(19) United States
(12) Patent Application Publication
(10) Pub. No.: US 2022/0329117 A1
(43) Pub. Date: Oct. 13, 2022

(54) STATOR CORE COOLING STRUCTURE AND MOTOR COOLING SYSTEM

(71) Applicant: Jing-Jin Electric Technologies Co., Ltd., Beijing (CN)

(72) Inventors: Ping YU, Beijing (CN); Xinliang LING, Beijing (CN); Yuxia HEI, Beijing (CN); Jiannan HOU, Beijing (CN); Haibin WANG, Beijing (CN)

(21) Appl. No.: 17/435,889

(22) PCT Filed: May 12, 2021
(86) PCT No.: PCT/CN2021/093369

§ 371 Date: Sep. 2, 2021

(30) Foreign Application Priority Data
May 27, 2020 (CN) 202010462729.6

(51) Int. Cl. H02K 1/20; H02K 5/20; H02K 5/173; H02K 9/193

(52) U.S. Cl. CPC H02K 1/20; H02K 5/203; H02K 5/1732; H02K 9/193

(57) ABSTRACT

A stator core cooling structure and a motor cooling system are provided. The stator core cooling structure includes a stator core and a motor housing. Axial grooves are distributed on an outer circumference of the stator core and/or an inner circumference of the motor housing, with the axial grooves extending in an axial direction of the stator core and/or the motor housing. The stator core is assembled in the motor housing, and cooling liquid passages are disposed between the stator core and the motor housing by the axial grooves, so that the cooling liquid cools the stator core via the cooling liquid passages.

### TECHNICAL FIELD

The present disclosure belongs to the field of motor technology, and in particular to a stator core cooling structure and a motor cooling system.

### BACKGROUND

At present, with the continuous development of the industry, the motor is required to have high performance such as high precision and high power density, which brings about a serious problem of motor heating. The motor heat cannot dissipate only by natural heat dissipation, and the external forced cooling is necessitated.

The conventional method of cooling the inside of motor is to form a groove on the inner wall of the motor housing to dispose a cooling oil circuit. However, the stator core cannot be directly cooled by providing such a cooling oil circuit, and there are problems such as long processing cycle, high manufacturing cost, and cumbersome assembly process when forming grooves on the inner wall of the motor housing.

### SUMMARY

In view of the technical problems in the prior art, the present disclosure provides a stator core cooling structure and a motor cooling system to solve or partially solve the above technical problems.

In order to achieve the above object, the present disclosure adopts the following technical solutions.

According to an aspect of the present disclosure, there is provided a stator core cooling structure, the stator core cooling structure comprises a stator core and a motor housing;

a plurality of axial grooves are distributed on an outer circumference of the stator core and/or an inner circumference of the motor housing, and the axial grooves extend in an axial direction of the stator core and/or the motor housing;

the stator core is assembled in the motor housing, and cooling liquid passages are formed between the stator core and the motor housing by the axial grooves.

Further, an inner wall of the motor housing is provided with an annular liquid distribution groove, and the cooling liquid is distributed to the cooling liquid passages via the liquid distribution groove.

Further, the stator core is composed of a plurality of stator punching pieces, and the stator punching pieces are formed by stamping.

According to an aspect of the present disclosure, there is provided a motor cooling system, the motor cooling system comprises a liquid inlet port, a liquid inlet passage, a liquid distribution passage, the stator core cooling structure described in any one of the above, and a liquid outlet port;

the liquid inlet port is arranged in an upper part of the motor housing, and communicates with the stator core cooling structure via the liquid inlet passage and the liquid distribution passage arranged in the motor housing, and the liquid outlet port is arranged on a lower part of a motor front-end cap and/or a motor rear-end cap and/or on a lower end of the motor housing.

Further, the liquid inlet passage and the liquid distribution passage are arranged in the upper part of the motor housing, and the liquid distribution passage is in communication with the liquid inlet passage;

the liquid distribution passage comprises a main passage extending in an axial direction in the upper part of the motor housing and a stator core cooling passage extending downward from the main passage.

Further, there are two main passages, which can be symmetrically arranged on both sides of a vertical center line of the motor housing.

Further, the motor cooling system further comprises a winding cooling structure, and the winding cooling structure is in communication with the main passage;

the liquid distribution passage further comprises a first winding cooling passage and a second winding cooling passage respectively extending downward from the main passage;

the winding cooling structure comprises a first cooling groove and a second cooling groove, the first cooling groove is in communication with the first winding cooling passage, and the second cooling groove is in communication with the second cooling passage;

the first cooling groove and the second cooling groove are annular and are respectively arranged on an inner wall of the motor housing, the first cooling groove corresponds to the front-end winding of the motor, and the second cooling groove corresponds to the rear-end winding of the motor.

Further, inner sides of the motor front-end cap and the motor rear-end cap are respectively provided with arc-shaped baffles, the first cooling groove and the second cooling groove are respectively assembled with the arc-shaped baffles to form annular passages, and a bottom of each annular passage is provided with a liquid spray nozzle.

Further, the motor cooling system further comprises a bearing lubrication structure, and the bearing lubrication structure is in communication with the main passage;

the liquid distribution passage further comprises a bearing lubrication passage arranged inside the motor front-end cap and the motor rear-end cap;

the bearing lubrication structure comprises a collection tank located in an upper part of a bearing chamber in the motor front-end cap and the motor rear-end cap, the collection tank is in communication with the bearing lubrication passage, and a lower end of the collection tank corresponds to a motor bearing.

Further, a drain tank is provided at a lower part of the bearing chamber or at a lower part of a stator installation position of a resolver, and the drain tank is connected to the liquid outlet port.

In sum, the beneficial effects of the present disclosure are as follows.

In the stator core cooling structure of the present disclosure, axial grooves are provided on the outer circumference of the stator core and/or on the inner circumference of the motor housing. When the stator core is assembled in the motor housing, the cooling liquid passages are formed between the stator core and the motor housing, so that the oil liquid directly contacts and cools the stator core, the contact area is large, and the cooling efficiency is high.

In the present disclosure, the axial grooves on the stator core are formed by stamping, and the stator core cooling structure is simple, thereby solving the problems in the prior art such as long processing cycle, high manufacturing cost, and cumbersome assembly process when forming grooves on the inner wall of the housing. Moreover, in the present disclosure, the motor cooling system can simultaneously realize the cooling of the stator core, the motor windings and the motor bearing, and the lubrication of the motor bearing, and the motor cooling system has a compact structure and good cooling and lubrication effects.

### BRIEF DESCRIPTION OF DRAWINGS

FIG. 1 is a schematic diagram of the structure of a stator core according to an embodiment of the present disclosure;

FIG. 2 is a schematic diagram of the structure of a motor housing according to an embodiment of the present disclosure;

FIG. 3 is a schematic diagram of the assembly of a stator core and a motor housing according to an embodiment of the present disclosure;

FIG. 4 is a right side view of a motor structure according to an embodiment of the present disclosure;

FIG. 5 is a front view of a motor structure according to an embodiment of the present disclosure; and

FIG. 6 is a schematic diagram of the structure of a motor front-end cap or a motor rear-end cap according to an embodiment of the present disclosure.

In the drawings: 1: a stator core; 2: a motor housing; 3: an axial groove; 4: a liquid distribution groove; 5: a liquid inlet port; 6: a liquid inlet passage; 7: a main passage; 8: a liquid outlet port; 9: a motor front-end cap; 10: a motor rear-end cap; 11: a first winding cooling passage; 12: a second winding cooling passage; 13: a stator core cooling passage; 14: a bearing lubrication passage; 15: a first cooling groove; 16: a second cooling groove; 17: an arc-shaped baffle; 18: a liquid spray nozzle; 19: a collection tank; 20: a drain tank.

### DETAILED DESCRIPTION

In order to make the objectives, technical solutions, and advantages of the present disclosure clearer, the embodiments of the present disclosure will be described in further detail in conjunction with the accompanying drawings.

In the description of the present disclosure, it should be noted that the terms “center”, “upper”, “lower”, “left”, “right”, “vertical”, “horizontal”, “inner”, “outer”, etc are orientation or positional relationship based on the drawings, which are merely for convenience of describing the present disclosure and simplifying the description, rather than indicating or implying that the device or component referred to must have a specific orientation, or must be constructed and operated with a specific orientation, so they should not be construed as limiting the present disclosure. In addition, the terms “first”, “second”, and “third” are only used for the purpose of description, and should not be construed as indicating or implying relative importance.

In the description of the present disclosure, it should be noted that, unless otherwise expressly defined and limited, the terms “installation”, “connected”, “connection” and the like should be broadly understood, for example, it may be fixedly connected, or detachably connected, or integrally connected; it may be mechanically connected, or electrically connected; it may e directly connected, or indirectly connected via an intermediate element; it may also be the internal communication of two components. For a person of ordinary skill in the art, the specific meaning of the above terms in the present disclosure should be understood according to specific circumstances.

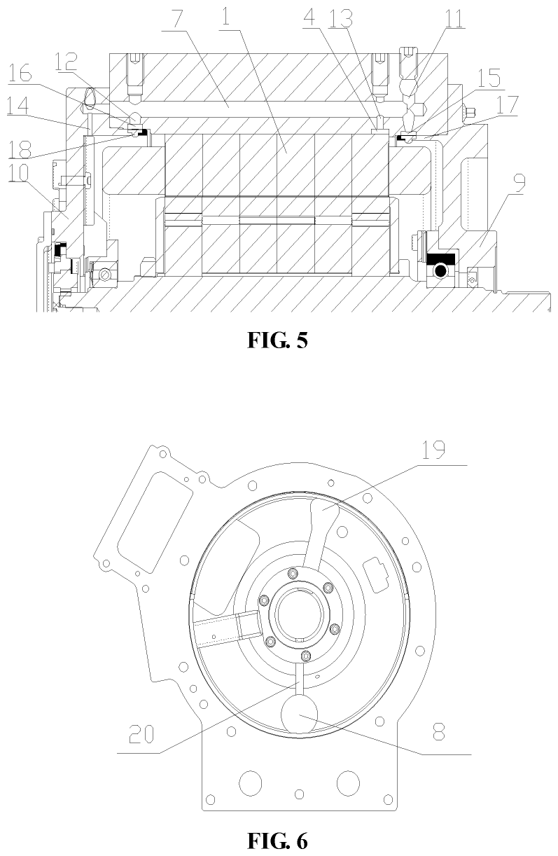

In order to describe the technical solution of the present disclosure more clearly, it is defined in FIGS. 4 and 6 that the left side is the front end or the front side, and the right side is the rear end or the rear side.

### First Embodiment

The embodiment of the present disclosure discloses a stator core cooling structure, which comprises a stator core 1 and a motor housing 2.

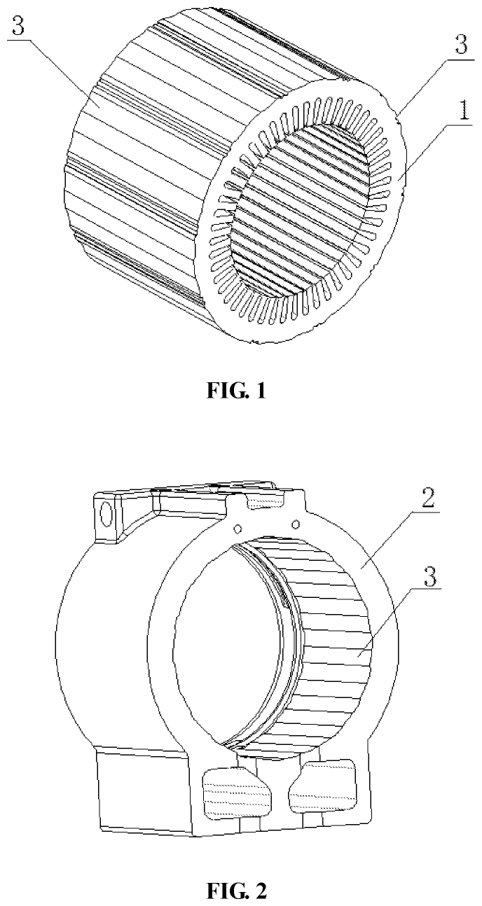

As shown in FIGS. 1-2, there are a plurality of axial grooves 3 distributed on the outer circumference of the stator core 1 and/or on the inner circumference of the motor housing 2. The axial grooves 3 can be of various shapes, such as arc-shaped grooves, V-shaped grooves, polygonal grooves, etc. The axial grooves 3 extend in the axial direction of the stator core 1 and/or the motor housing 2. The axial grooves 3 provided on the stator core 1 extend through the entire stator core 1. The axial grooves 3 provided on the motor housing 2 extend longer than the thickness of the stator core 1, and directly faces the stator core 1. The number and position distribution of the axial grooves 3 can be adjusted according to actual needs.

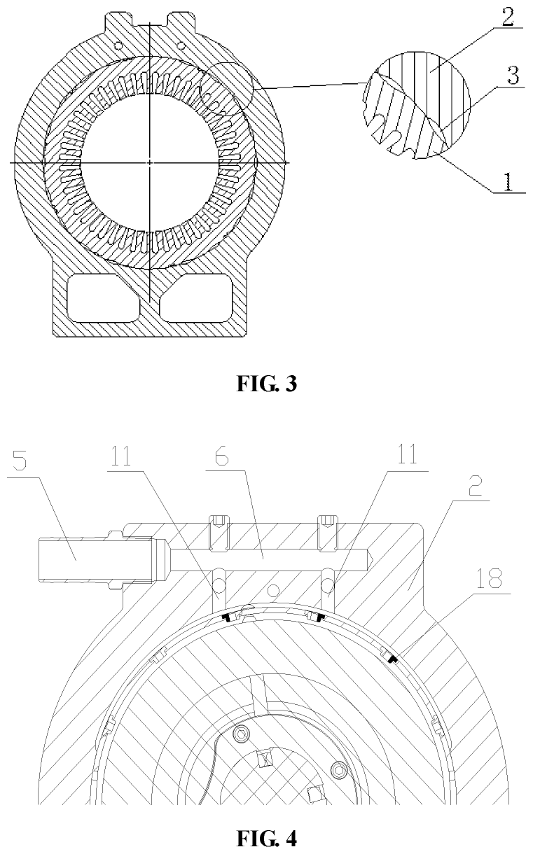

The stator core 1 is assembled in the motor housing 2. As can be seen from FIG. 3, cooling liquid passages are formed between the stator core 1 and the motor housing 2. The cooling liquid cools the stator core 1 via the cooling liquid passages.

In the stator core cooling structure of the present disclosure, the axial groove 3 may be provided on the stator core 1 or the motor housing 2 or both the stator core 1 and the motor housing 2. Due to the design of the axial groove 3, when the stator core 1 is assembled in the motor housing 2, cooling passages are formed between the stator core 1 and the motor housing 2, via which the oil liquid can directly contact and cool the stator core 1, so the contact area is large, the cooling efficiency is high; moreover, the stator core cooling structure is simple, which solves the problems in the prior art such as long processing cycle, high manufacturing cost, and cumbersome assembly process when forming grooves on the inner wall of the housing.

In an embodiment (mode), the axial grooves can be formed by stacking a plurality of punching pieces, which avoids the problems such as long processing cycle, high manufacturing cost, and cumbersome assembly process when forming grooves on the inner wall of the housing.

An annular liquid distribution groove 4 is provided on the inner wall of the motor housing 2 and communicates with the axial groove 3. The cooling liquid is distributed to the cooling liquid passages via the liquid distribution groove 4. It can be seen from FIG. 4 that the position of the liquid distribution groove 4 faces the stator core 1, and can correspond to an end of the stator core 1 or the middle area of the stator core 1 to achieve the flow of the cooling liquid from one end of the cooling passage to the other end, or from the middle of the cooling passage to both ends. The cooling liquid enters the liquid distribution groove 4 and flows around the motor housing 1, and then is distributed into the cooling liquid passages to take away the heat on the surface of the stator core 1, thereby realizing the cooling of the stator core 1.

In an embodiment, the stator core 1 is composed of a plurality of stator punching pieces. The number of stator punching pieces can be adjusted according to actual needs. The stator punching pieces are formed by stamping, and are simple to manufacture.

### Second Embodiment

The embodiment of the present disclosure discloses a motor cooling system, as shown in FIGS. 4-6, the motor cooling system comprises a liquid inlet port 5, a liquid inlet passage 6, a liquid distribution passage, any one of the above stator core cooling structures, and an liquid outlet port 8.

The liquid inlet port 5 arranged above the motor housing 2 communicates with the stator core cooling structure via the liquid inlet passage 6 and the liquid distribution passage arranged in the motor housing 2. There are one or more liquid outlet ports 8 arranged on a lower part of a motor front-end cap 9 and/or a motor rear-end cap 10, and/or on a lower end of the motor housing 2, so that the oil liquid can be discharged from the inside of the motor after cooling and lubrication are completed.

In this embodiment, the oil liquid enters the motor cooling system via the liquid inlet port 5, enters the main passage 7 of the liquid distribution passage via the liquid inlet passage 6, and then enters the stator core cooling structure via the main passage 7 of the liquid distribution passage, and then the cooling of the stator core 1 is realized, and the oil liquid after cooled is discharged from the motor cooling system via the liquid outlet port 8. The motor cooling system in this embodiment can cool the stator core, and has a compact structure and good cooling and lubrication effects.

In an embodiment (mode), as shown in FIGS. 4 and 5, the liquid inlet passage 6 and the liquid distribution passage are arranged in the upper part of the motor housing 2. The liquid inlet passage 6 and the main passage 7 of the liquid distribution passage may be provided to be vertically communicated, in which the main passage 7 of the liquid distribution passage extends axially in the upper part of the motor housing 2 and extends through the motor housing 2, so that the oil liquid can flow to the two ends of the motor, and thus the cooling of the windings at both ends of the motor and the lubricating of the bearings at both ends are realized.

With reference to FIGS. 4 and 5, a stator core cooling passage 13 may be arranged perpendicular to the main passage 7 and extend downward. The stator core cooling passage 13 is arranged between the main passage 7 of the liquid distribution passage and the liquid distribution groove 4, and has a communication function for guiding the oil liquid in the liquid distribution passage 7 to the liquid distribution groove 4. The oil liquid is distributed into the cooling liquid passages in the stator core cooling structure by the liquid distribution groove 4, and then cools the stator core 1.

In an embodiment, preferably, there are two main passages 7 of the liquid distribution passage, which may be symmetrically arranged on both sides of the vertical center line of the motor housing 2. Correspondingly, there are also two stator core cooling passages 13. In actual processing, the number of main passages 7 can be adjusted according to actual needs.

In an embodiment, as shown in FIGS. 4-5, the motor cooling system further comprises a winding cooling structure, which is connected to the main passage 7. The winding cooling structure can realize the cooling of the front and rear motor windings.

The main passage 7 further comprises a first winding cooling passage 11 and a second winding cooling passage 12 respectively arranged downward.

The oil liquid in the main passage 7 can pass through the first winding cooling passage 11 and the second winding cooling passage 12 to cool the front-end winding and the rear-end winding of the motor. The winding cooling structure comprises a first cooling groove 15 and a second cooling groove 16. The first cooling groove 15 is in communication with the first winding cooling passage 11, and the second cooling groove 16 is in communication with the second cooling passage 12. The oil liquid from the main passage 7 of the liquid distribution passage enters the first cooling groove 15 via the first winding cooling passage 11, and enters the second cooling groove 16 via the second cooling passage 12.

The first cooling groove 15 and the second cooling groove 16 are annular and are respectively arranged on the inner wall of the motor housing 2. The first cooling groove 15 corresponds to the front-end winding of the motor, and the second cooling groove 16 corresponds to the rear-end winding of the motor.

In an embodiment, the inner sides of the motor front-end cap 9 and the motor rear-end cap 10 are respectively provided with arc-shaped baffles 17, and the first cooling groove 15 and the second cooling groove 16 are respectively assembled with the arc-shaped baffles 17 to form annular passages. The bottom of each annular passage is provided with a liquid spray nozzle 18. There can be a plurality of liquid spray nozzles 18 arranged evenly. The oil liquid in the annular passage may be sprayed onto the motor windings by the liquid spray nozzles 18 to realize the cooling of the motor windings. The liquid spray nozzle 18 and the arc-shaped baffle 17 may be integrated or assembled.

In an embodiment, as shown in FIGS. 5 and 6, the motor cooling system further comprises a bearing lubrication structure which is in communication with the main passage 7. The bearing lubrication structure can realize the lubrication and cooling of the bearing.

The liquid distribution passage also comprises a bearing lubrication passage 14 arranged inside the motor front-end cap and the motor rear-end cap.

The oil liquid in the main passage 7 passes through the bearing lubrication passage 14 to cool and lubricate the front and rear bearings. The bearing lubrication structure comprises a collection tank 19 arranged in upper parts of the bearing chambers in the motor front-end cap 9 and the motor rear-end cap 10, respectively. The upper ends of the collection tanks 19 communicate with the bearing lubrication passages 14 provided inside the motor front-end cap 9 and the motor rear-end cap 10, and the lower end of the collection tank 19 corresponds to the motor bearing.

The oil liquid in the main passage 7 flows into the collection tank 19 via the bearing lubrication passage 14, and then flows from the collection tank 19 to the motor bearing to lubricate and cool the motor bearing. In addition, an upper end of the collection tank 19 is preferably in the shape of a funnel so as to facilitate the flow of oil liquid in the bearing lubrication passage 14 into the collection tank 19.

In an embodiment, as shown in FIG. 6, a drain tank 20 is provided in the lower part of the bearing chamber in the motor front-end cap 9 and/or the motor rear-end cap 10. The drain tank 20 may also be provided at the lower end of the stator installation position of a resolver. The drain tank 20 can receive the cooling liquid flowing out of the above cooling structures, which can prevent oil liquid stirring and temperature increase caused by excessive oil liquid, thereby avoiding the deterioration of performance and efficiency of the motor. The liquid drain tank 20 is connected to the liquid outlet port 8, and the oil liquid in the drain tank 20 can be discharged via the liquid outlet port 8.

In the present disclosure, the oil liquid enters the motor cooling system from the liquid inlet port 5, then flows through the liquid inlet passage 6 and the main passage 7 in sequence, and then flows from the main passage 7 into the first winding cooling passage 11, the second winding cooling passage 12, the stator core cooling passage 13 and the bearing lubrication passage 14. The oil liquid in the first winding cooling passage 11 is sprayed onto the front-end winding of the motor via the first cooling groove 15 and the liquid spray nozzle 18. The oil liquid in the second winding cooling passage 12 is sprayed onto the rear-end winding of the motor via the second cooling groove 16 and the liquid spray nozzle 18. The oil liquid in the stator core cooling passage 13 flows into the cooling liquid passage formed by the axial groove 3 and the inner wall of the motor housing 2 via the liquid distribution groove 4. The oil liquid in the bearing lubrication passage 14 flows to the motor bearing via the collection tank 19. Finally, the oil liquid flows out of the motor cooling system via the liquid outlet port 8. The motor cooling system can cool the stator core 1, motor windings and motor bearing, and lubricate the motor bearing.

The above description is only specific embodiments of the present disclosure. Based on the above teachings of the present disclosure, those skilled in the art can make other improvements or modifications on the basis of the above embodiments. Those skilled in the art should understand that the above specific description is only for better explaining the present disclosure, and the protection scope of the present disclosure should be subject to the protection scope of the claims.

1. A stator core cooling structure comprising:
a stator core and a motor housing;
a plurality of axial grooves distributed on an outer circumference of the stator core and/or an inner circumference of the motor housing, with the axial grooves extending in an axial direction of the stator core and/or the motor housing;
wherein the stator core is assembled in the motor housing, and cooling liquid passages are disposed between the stator core and the motor housing by the axial grooves.

2. The stator core cooling structure according to claim 1, wherein an inner wall of the motor housing is provided with an annular liquid distribution groove, and the cooling liquid is distributed to the cooling liquid passages via the liquid distribution groove.

3. The motor cooling system according to claim 1, wherein the stator core is composed of a plurality of stator punching pieces, and the stator punching pieces are formed by stamping.

4. A motor cooling system comprising:
a liquid inlet port, a liquid inlet passage, a liquid distribution passage, the stator core cooling structure according to claim 1, and a liquid outlet port;
wherein the liquid inlet port is arranged in an upper part of the motor housing, and communicates with the stator core cooling structure via the liquid inlet passage and the liquid distribution passage arranged in the motor housing, and the liquid outlet port is arranged on a lower part of a motor front-end cap and/or a motor rear-end cap and/or on a lower end of the motor housing.

5. The motor cooling system according to claim 4,
wherein the liquid inlet passage and the liquid distribution passage are arranged in the upper part of the motor housing, and the liquid distribution passage is in communication with the liquid inlet passage; and
wherein the liquid distribution passage comprises a main passage extending in an axial direction in the upper part of the motor housing and a stator core cooling passage extending downward from the main passage.

6. The motor cooling system according to claim 5, wherein there are two main passages, which can be symmetrically arranged on both sides of a vertical center line of the motor housing.

7. The motor cooling system according to claim 5,
wherein the motor cooling system further comprises a winding cooling structure, and the winding cooling structure is in communication with the main passage;
wherein the liquid distribution passage further comprises a first winding cooling passage and a second winding cooling passage respectively extending downward from the main passage;
wherein the winding cooling structure comprises a first cooling groove and a second cooling groove, the first cooling groove is in communication with the first winding cooling passage, and the second cooling groove is in communication with the second cooling passage; and
wherein the first cooling groove and the second cooling groove are annular and are respectively arranged on an inner wall of the motor housing, the first cooling groove corresponds to the front-end winding of the motor, and the second cooling groove corresponds to the rear-end winding of the motor.

8. The motor cooling system according to claim 7, wherein inner sides of the motor front-end cap and the motor rear-end cap are respectively provided with arc-shaped baffles, the first cooling groove and the second cooling groove are respectively assembled with the arc-shaped baffles to form annular passages, and a bottom of each annular passage is provided with a liquid spray nozzle.

9. The motor cooling system according to claim 5,
wherein the motor cooling system further comprises a bearing lubrication structure, and the bearing lubrication structure is in communication with the main passage;
wherein the liquid distribution passage further comprises a bearing lubrication passage arranged inside the motor front-end cap and the motor rear-end cap; and
wherein the bearing lubrication structure comprises a collection tank located in an upper part of a bearing chamber in the motor front-end cap and the motor rear-end cap, the collection tank is in communication with the bearing lubrication passage, and a lower end of the collection tank corresponds to a motor bearing.

10. The motor cooling system according to claim 9, wherein the drain tank is provided at a lower part of the bearing chamber or at a lower part of a stator installation position of a resolver, and the drain tank is connected to the liquid outlet port.

11. A motor cooling system comprising:
a liquid inlet port, a liquid inlet passage, a liquid distribution passage, the stator core cooling structure according to claim 2, and a liquid outlet port;
wherein the liquid inlet port is arranged in an upper part of the motor housing, and communicates with the stator core cooling structure via the liquid inlet passage and the liquid distribution passage arranged in the motor housing, and the liquid outlet port is arranged on a lower part of a motor front-end cap and/or a motor rear-end cap and/or on a lower end of the motor housing.

12. A motor cooling system comprising:
a liquid inlet port, a liquid inlet passage, a liquid distribution passage, the stator core cooling structure according to claim 3, and a liquid outlet port;
wherein the liquid inlet port is arranged in an upper part of the motor housing, and communicates with the stator core cooling structure via the liquid inlet passage and the liquid distribution passage arranged in the motor housing, and the liquid outlet port is arranged on a lower part of a motor front-end cap and/or a motor rear-end cap and/or on a lower end of the motor housing.
